(19) United States
(12) Patent Application Publication
(10) Pub. No.: US 2026/0301012 A1
(43) Pub. Date: Oct. 1, 2026

(54) SYSTEMS AND METHODS FOR ANALYZING TARGET VARIABLE OF INTEREST RELATED TO USER-DEFINED TRENDS OF INTEREST

(71) Applicant: Panasonic Intellectual Property Management Co., Ltd., Osaka (JP)

(72) Inventors: DEBDEEP PAUL, Singapore (SG); YONGNING YIN, Singapore (SG); CHANDRA SUWANDI WIJAYA, Singapore (SG); SAHIM YAMAURA, Singapore (SG); KOJI MIURA, Osaka (JP); YOSUKE TAJIKA, Hyogo (JP)

(21) Appl. No.: 19/090,458

(22) Filed: Mar. 26, 2025

(51) Int. Cl. G06Q 30/0204; G06Q 30/0202

(52) U.S. Cl. CPC G06Q 30/0204; G06Q 30/0202

(57) ABSTRACT

Disclosed herein are systems and methods for analyzing a target variable of interest with respect to one or more user-defined trends of interest is disclosed. Initially, the target variable of interest is segmented into two or more segments. Further, one or more trend scores are determined based on corresponding intensities of the one or more user-defined trends of interest for each data point within the two or more segments. Furthermore, distribution of the one or more trend scores across each of the two or more segments is determined and a representation of the distribution is generated indicative of the analysis of the target variable of interest with respect to the one or more user-defined trends of interest.

### TECHNICAL FIELD

The present disclosure relates to a field of generating forecasts, and more particularly relates to systems and methods for target variable of interest with respect to user-defined trends of interest.

### BACKGROUND

The information in this section merely provides background information related to the present disclosure and may not constitute prior art(s) for the present disclosure.

Time-dependent data, also known as time series data, is a sequence of data points collected or recorded at successive points in time. This type of data is characterized by its sequential nature, where each data point is associated with a timestamp, enabling the analysis of how a particular variable changes over time. Such time-dependent data is prevalent in business applications across various industrial sectors such as, but not limited to, finance, healthcare, communication systems, power systems, business metrices, Internet of Things (IoT), and website traffic metrics. Time-dependent data is fundamental in many fields, including finance, economics, operations, and healthcare, where understanding the dynamics of change over time is critical.

Further, analyzing the time-dependent data is essential for industries where understanding the dynamics of change over time is critical. Furthermore, analysis of the time-dependent provides insights into trends, patterns, and behaviours over time, facilitating informed decision-making by stakeholders. By examining the time-dependent data, seasonal fluctuations may be detected facilitating understanding of long-term trends, and forecasting future performances, which are vital for strategic planning and resource allocation. Therefore, leveraging time-dependent data enhances the ability to adapt, optimize processes, and improve overall performance in a competitive landscape.

Various techniques are used for analysis of time series data. For example, sequence segmentation is an important technique in analyzing time-dependent data which focusses on identifying structural changes within the data over time based on change point detection. The change point detection aims to determine moments when a significant shift occurs in the statistical properties of a time series, such as a change in mean, variance, or trend. These shifts indicate transitions in the underlying process generating the data and detecting them can provide insights into phenomena such as economic shifts, climate changes, or anomalies in system performance.

Currently available techniques for change point detection, segment classification and time series analysis mostly leverage unsupervised machine learning (ML) techniques to generate segments of distinct statistical characteristics. In the unsupervised ML based techniques, typically a set of related features are used to train different ML models, and a forecast is made on the unseen data.

However, trends forecasted using conventional techniques leveraging the unsupervised ML models tend to be generic and may not adequately address specific user needs. In particular, the existing solutions fail to provide forecasts of trends that align with user-defined trends or patterns of interest in a time series.

Therefore, in view of the above-mentioned problems, it is advantageous to provide an improved system and method that can overcome the above-mentioned problems and limitations associated with analysis of time series data in view of user-defined trends or patterns of interest.

### SUMMARY

This summary is provided to introduce a selection of concepts, in a simplified format, that are further described in the detailed description of the invention. This summary is neither intended to identify key or essential inventive concepts of the invention nor intended to determine the scope of the invention.

In an embodiment of the present disclosure, a method for analyzing a target variable of interest with respect to one or more user-defined trends of interest is disclosed. The method includes obtaining, by a processor, the target variable of interest and the one or more user-defined trends of interest, such that the target variable of interest corresponds to a plurality of sequential data points. The method also includes segmenting the target variable of interest into two or more segments. Further, the method includes determining one or more trend scores based on corresponding intensities of the one or more user-defined trends of interest for each data point within the two or more segments. Furthermore, the method includes determining distribution of the one or more trend scores across each of the two or more segments. Moreover, the method includes generating a representation corresponding to the distribution of the one or more trend scores, such that the representation is indicative of the analysis of the target variable of interest with respect to the one or more user-defined trends of interest.

In an embodiment of the present disclosure, a system for analyzing a target variable of interest with respect to one or more user-defined trends of interest is disclosed. The system includes a memory, and a processor coupled with the memory. The processor is configured to obtain the target variable of interest and the one or more user-defined trends of interest, such that the target variable of interest corresponds to a plurality of sequential data points. Further, the processor is configured to segment the target variable of interest into two or more segments and determine one or more trend scores based on corresponding intensities of the one or more user-defined trends of interest for each data point within the two or more segments. Furthermore, the processor is configured to determine distribution of the one or more trend scores across each of the two or more segments. Moreover, the processor is configured to generate a representation corresponding to the distribution of the one or more trend scores, such that the representation is indicative of the analysis of the target variable of interest with respect to the one or more user-defined trends of interest.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic block diagram of a system for analyzing a target variable of interest with respect to one or more user-defined trends of interest, according to an embodiment of the present disclosure;

FIG. 2 is a schematic block diagram depicting the one or more modules of the system for analyzing the target variable of interest with respect to the one or more user-defined trends of interest, according to an embodiment of the present disclosure;

FIG. 3 illustrates an exemplary process flow comprising a method for analyzing the target variable of interest with respect to the one or more user-defined trends of interest, according to an embodiment of the present disclosure; and

FIGS. 4A and 4B illustrate another exemplary workflow for implementing the method and a graphical user interface (GUI) respectively for analyzing the target variable of interest with respect to the one or more user-defined trends of interest, according to an embodiment of the present disclosure.

Further, skilled artisans will appreciate that elements in the drawings are illustrated for simplicity and may not have necessarily been drawn to scale. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

For the purpose of promoting an understanding of the principles of the present disclosure, reference will now be made to the various embodiments and specific language will be used to describe the same. It will nevertheless be understood that no limitation of the scope of the present disclosure is thereby intended, such alterations and further modifications in the illustrated system, and such further applications of the principles of the present disclosure as illustrated therein being contemplated as would normally occur to one skilled in the art to which the present disclosure relates.

It will be understood by those skilled in the art that the foregoing general description and the following detailed description are explanatory of the present disclosure and are not intended to be restrictive thereof.

Whether or not a certain feature or element was limited to being used only once, it may still be referred to as “one or more features” or “one or more elements” or “at least one feature” or “at least one element.” Furthermore, the use of the terms “one or more” or “at least one” feature or element do not preclude there being none of that feature or element, unless otherwise specified by limiting language including, but not limited to, “there needs to be one or more . . . ” or “one or more elements is required.”

Reference is made herein to some “embodiments.” It should be understood that an embodiment is an example of a possible implementation of any features and/or elements of the present disclosure. Some embodiments have been described for the purpose of explaining one or more of the potential ways in which the specific features and/or elements of the proposed disclosure fulfil the requirements of uniqueness, utility, and non-obviousness.

Use of the phrases and/or terms including, but not limited to, “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or other variants thereof do not necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or in the context of more than one embodiment, or in the context of all embodiments, the features and/or elements may instead be provided separately or in any appropriate combination or not at all. Conversely, any features and/or elements described in the context of separate embodiments may alternatively be realized as existing together in the context of a single embodiment.

Any particular and all details set forth herein are used in the context of some embodiments and therefore should not necessarily be taken as limiting factors to the proposed disclosure.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

A detailed methodology is explained in the following paragraphs of the disclosure.

Embodiments of the present disclosure will be described below in detail with reference to the accompanying drawings.

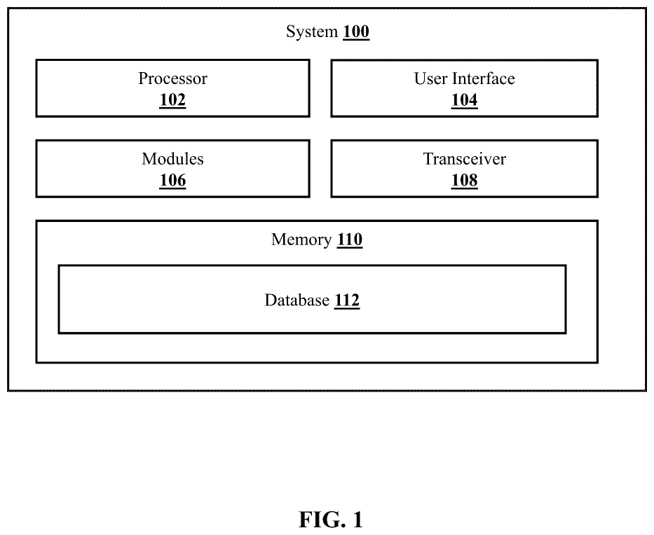

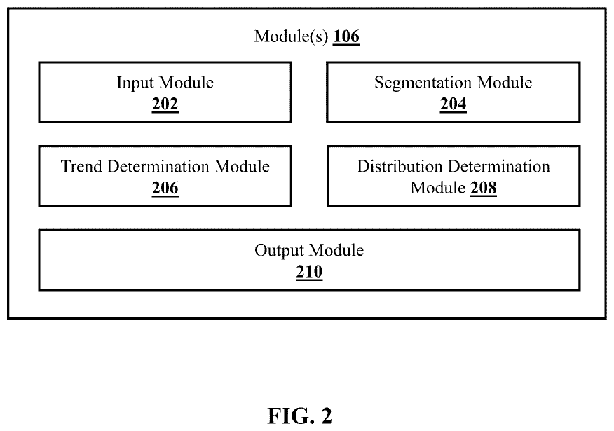

For the sake of clarity, the first digit of a reference numeral of each component of the present disclosure is indicative of the Figure number, in which the corresponding component is shown. For example, reference numerals starting with digit “1” are shown at least in FIG. 1. Similarly, reference numerals starting with digit “2” are shown at least in FIG. 2.

The present disclosure proposes a joint framework for using unsupervised learning based change point detection techniques for detecting and analyzing generic unsupervised change points, and a supervised technique to model a predefined and arbitrary specific change such as plummets, recovery from plummet, segments with different degrees of fluctuation (e.g., high, medium, low etc.). Further, the present disclosure proposes a combination of both supervised and unsupervised family of methods for change point detection and segmentation in the lens of one or more user-defined trends of interest. The segmentation is carried out by using an ensemble of unsupervised methods with different objective functions capturing a broad spectrum of statistical properties for detecting the change points. The present disclosure proposes designing specific functions to canonicalize and normalize scores maximized or minimized by individual methods to develop a generic objective function. Thus, the present disclosure provides a robust, and probabilistic framework for quantifying evolution of specific trend defined qualitatively by a user across a plurality of segments where a target timeseries data is experiencing generic changes.

According to various embodiments of the present disclosure, the joint framework detects general unsupervised change points through multiple unsupervised learning based change point detection techniques, while a supervised method models specific, predefined changes such as plummets or recoveries. The present disclosure further relates to a system configured to assign a score for characterizing the plurality of segments based on corresponding intensities of the one or more user-defined trends of interest. The system utilizes an appropriate scoring function and is further configured to design a customized function for transforming continuous variables into discrete states. In particular, the system employs a Markov chain-based approach to model state transitions, ensuring a probabilistic framework for segment characterization and transformation. Furthermore, the system leverages machine learning (ML) techniques trained on historical data to predict future trends. The training process includes dataset partitioning into training, validation, and test sets, enabling robust model generalization and accurate forecasting of segment behaviour.

Further, the present disclosure provides a methodology for providing explainability in terms of the features used for training and forecasting target variable that can be encoded to a discrete set of states to formulate a classification method. According to various embodiments of the present disclosure, said methodology forecast future change point segments and their specific nature based on one or more user-defined trends or patterns of interest.

According to various embodiments of the present disclosure, a methodology is disclosed for segmentation of time-dependent data or time series data. Said time series segmentation involves dividing the time series into distinct segments where each segment is assumed to have homogeneous properties. This segmentation helps simplify the analysis, enabling the identification of different regimes or behaviors within the series. Said technique can be widely used in fields like finance, healthcare, and engineering for tasks such as anomaly detection, predictive modeling, fault detection, cybersecurity, industrial automation, environmental science, transportation & logistics, retail & marketing, energy management, and telecommunications. Further, detecting change points and segmenting time series enables better understanding of the dynamics of complex systems and respond to critical shifts in real-time.

According to various embodiments of the present disclosure, a forecasting methodology to address the issues of analyzing a target variable of interest with respect to one or more user-defined trends of interest is disclosed.

Conventionally, it is observed that the methods for forecasting timeseries ranges from traditional models such as autoregressive integrated moving average (ARIMA) model to modern machine learning (ML) based models. However, in ML based paradigms, a set of related features is used to train different ML models, and the forecast is made on the unseen data. Therefore, the present disclosure is directed towards utilizing target variable of interest, auxiliary features to the target variable of interest, one or more user-defined trends of interest, predefined unsupervised learning based change point detection methods received as inputs to segment the target variable of interest and applying supervised learning based method to generate trend scores for each segment of the time series data. However, in such models, a set of related features is used to train different ML models, and the forecast is made on the unseen data.

FIG. 1 is a schematic block diagram of a system 100 for analyzing a target variable of interest with respect to one or more user-defined trends of interest, according to an embodiment of the present disclosure. In one embodiment, the system 100 may be used to implement the methods for analyzing the target variable of interest with respect to the one or more user-defined trends of interest, as discussed hereinafter.

In an embodiment, the system 100 may be implemented within a mobile device or a server. One or more examples of the mobile device may include, but not limited to, a laptop, a smart phone, a tablet, a phablet or any electronic device capable of accessing internet and installing a software application(s). The system 100 may further include a processor 102, a user interface 104, one or more modules 106, transceiver 108, and a memory 110.

In some embodiments, the memory 110 may be communicatively coupled to the at least one processor 102. The memory 110 may be configured to store data, instructions executable by the at least one processor 102. In some embodiments, the one or more modules 106 may be included within the memory 110. The memory 110 may further include a database 112 to store data. The one or more modules 106 may include a set of instructions that may be executed to cause the system 100 to perform any one or more of the methods disclosed herein. The one or more modules 106 may be configured to perform the steps of the present disclosure using the data stored in the database 112, to analyze time-dependent data, as discussed throughout this disclosure.

In an embodiment, each of the one or more modules 106 may be a hardware unit which may be outside the memory 110. The transceiver 108 may be capable of receiving and transmitting signals to and from system 100. The user interface 104 may include a display interface configured to receive user inputs and display output of the system 100 for the user(s). Specifically, the user interface 104 may provide a display function and one or more physical buttons on the system 100 to input/output various functions, as discussed herein. Other forms of input/output such as by voice, gesture, signals, etc. are well within the scope of the present disclosure.

At least one of the one or more of modules may be implemented through an AI model. A function associated with AI may be performed through the non-volatile memory, the volatile memory, and the processor.

The processor 102 may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or artificial intelligence (AI) model stored in the non-volatile memory and the volatile memory. The predefined operating rule or artificial intelligence model is provided through training or learning.

Here, being provided through learning means that, by applying a learning technique to a plurality of learning data, a predefined operating rule or AI model of a desired characteristic is made. The learning may be performed in a device itself in which AI according to an embodiment is performed, and/or may be implemented through a separate server/system.

In some embodiments, the AI model may include a plurality of neural network layers, each comprising a plurality of weight values. Each layer may be configured to perform operations based on computations from a preceding layer and weight adjustments through a training process. The neural network may be implemented using various architectures including, but not limited to, convolutional neural networks (CNNs), deep neural networks (DNNs), recurrent neural networks (RNNs), restricted Boltzmann machines (RBMs), deep belief networks (DBNs), bidirectional recurrent deep neural networks (BRDNNs), generative adversarial networks (GANs), and deep Q-networks (DQNs). These architectures may be utilized for learning complex patterns, feature extraction, sequence modeling, and decision-making based on historical data, enabling robust forecasting and anomaly detection.

The learning technique is a method for training a predetermined target device (for example, a robot) using a plurality of learning data to cause, allow, or control the target device to make a determination or prediction. Examples of learning techniques include, but are not limited to, supervised learning, unsupervised learning, semi-supervised learning, or reinforcement learning.

According to the disclosure, in a method of an electronic device, a method for generating a plurality of instructions for enhancing motor skills of a user may use an artificial intelligence model to recommend/execute the plurality of instructions by using sensor data. The processor 102 may perform a pre-processing operation on the data to convert into a form appropriate for use as an input for the artificial intelligence model. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training technique. The artificial intelligence model may include a plurality of neural network layers. Each of the plurality of neural network layers includes a plurality of weight values and performs neural network computation by computation between a result of computation by a previous layer and the plurality of weight values.

Reasoning prediction is a technique of logically reasoning and predicting by determining information and includes, e.g., knowledge-based reasoning, optimization prediction, preference-based planning, or recommendation.

For the sake of brevity, the architecture and standard operations of the processor 102, the user interface 104, the memory 110, the database 112, and the transceiver 108 are not discussed in detail.

In one embodiment, the database 112 may be configured to store the information as required by the one or more modules 106 and the processor 102 to perform one or more functions to generate a representation corresponding to a distribution of the one or more trend scores determined based on intensities of one or more user-defined trends of interest.

In one embodiment, the memory 110 may communicate via a bus (not shown) within the system 100. The memory 110 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 110 may include a cache or random-access memory for the processor 102. In alternative examples, the memory 110 is separate from the processor 102, such as a cache memory of a processor, the system memory, or other memory. The memory 110 may be an external storage device or database for storing data. The memory 110 may be operable to store instructions executable by the processor 102. The functions, acts or tasks illustrated in the figures or described may be performed by the programmed processor 102 for executing the instructions stored in the memory 110. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

Further, the present invention contemplates a computer-readable medium that includes instructions or receives and executes instructions responsive to a propagated signal, so that a device connected to a network may communicate voice, video, audio, images, or any other data over a network. Further, the instructions may be transmitted or received over the network via a communication port or interface or using a bus (not shown). The communication port or interface may be a part of the processor 102 or maybe a separate component. The communication port may be created in software or maybe a physical connection in hardware. The communication port may be configured to connect with a network, external media, the display, or any other components in the system 100, or combinations thereof. The connection with the network may be a physical connection, such as a wired Ethernet connection or may be established wirelessly. Likewise, the additional connections with other components of the system 100 may be physical or may be established wirelessly. The network may alternatively be directly connected to the bus.

In one embodiment, the processor 102 may include at least one data processor for executing processes in Virtual Storage Area Network. The processor 102 may include specialized processing units such as, integrated system (bus) controllers, memory management control units, floating point units, graphics processing units, digital signal processing units, etc. In one embodiment, the processor 102 may include a central processing unit (CPU), a graphics processing unit (GPU), or both. The processor 102 may be one or more general processors, digital signal processors, application-specific integrated circuits, field-programmable gate arrays, servers, networks, digital circuits, analog circuits, combinations thereof, or other now known or later developed devices for analyzing and processing data. The processor 102 may implement a software program, such as code generated manually (i.e., programmed).

The processor 102 may be disposed in communication with one or more input/output (I/O) devices via the I/O interface 104. The I/O interface 104 may employ communication code-division multiple access (CDMA), high-speed packet access (HSPA+), global system for mobile communications (GSM), long-term evolution (LTE), WiMax, or the like, etc.

The processor 102 may be disposed in communication with a communication network via a network interface. The network interface may be the I/O interface 104. The network interface may connect to a communication network. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

FIG. 2 is a schematic block diagram depicting the one or more modules 106 of the system 100 for analyzing a target variable of interest with respect to one or more user-defined trends of interest, according to an embodiment of the present disclosure.

As depicted in the figure, the one or more modules 106 may include an input module 202, a segmentation module 204, a trend determination module 206, and an output module 208.

In an embodiment, the input module 202 may be configured to receive a data model indicative of a transformation of time series. The time series may be related to any process such as stocks, temperature, manufacturing, sales, marketing etc.

Further, the input module 202 may be configured to obtain target variable of interest and a set of auxiliary features to the target variable of interest. The target variable of interest corresponds to a plurality of sequential data points. Further, the target variable of interest may be an attribute or element represented in the data model which is to be analysed with respect to one or more user-defined trends of interest. In an example, the target variable of interest may include, but not limited to, a plurality of sequential data points associated with stock prices. In an embodiment, the target variable of interest may be a quantity or a data item for which analysis respect to one or more user-defined trends of interest is required.

Further, the set of auxiliary features may indicate latent information corresponding to the target variable of interest. The set of auxiliary features may include, but not limited to, information content, correlation and other related metrices

In an exemplary scenario of stock price monitoring, where the target variable is the temporal stock price of a specific company, the auxiliary variables may include indices derived from various factors, such as market sentiment (e.g., social media sentiment analysis, news headlines, and investor sentiment indices), macroeconomic indicators (e.g., Gross Domestic Product (GDP) growth, inflation, unemployment rate, and interest rates), analyst reports (e.g., buy/sell recommendations and earnings forecasts), company performance (e.g., quarterly sales, revenue, profit margins, and earnings per share), government policies (e.g., tax reforms, monetary policy, new regulations, and trade policies), and global stock market indices trends. According to various embodiments of the present disclosure, the set of auxiliary features may vary according to the target variable of interest.

In another exemplary scenario of sales forecasting, the target variable is sales volume of a product. The corresponding auxiliary variables may include numerical indices derived from various factors, such as past sales data (e.g., seasonal trends and promotions), marketing expenditure (e.g., advertising budget and social media reach), competitor activity (e.g., price changes and new product launches), and economic indicators (e.g., consumer confidence index and inflation).

In yet another exemplary scenario of energy demand prediction, the target variable may include a sequence of electricity consumption values over time. The auxiliary variables may include indices generated from various factors, such as weather conditions (e.g., temperature, humidity, and precipitation), industrial activity (e.g., factory output and production schedules), time-based factors (e.g., peak hours, weekends vs. weekdays, and seasonal variations), and energy pricing factors (e.g., changes in tariffs and subsidies).

Further, the input module 202 may be configured to receive a number of states. In some embodiments, the target variable of interest may be classified into one or more states. The one or more states may correspond to one or more divisions within the data model enabling the classification of the target variable of interest based on a predefined condition.

In an example, in the context of stock price monitoring, the one or more states may include, but not limited to, a high, a medium, and a low state of stock price. Further, the predefined condition may include a threshold or a threshold range of stock price for each of the one or more states. Thus, the target variable of interest, i.e., the stock price of a company may be classified in one the high, medium, and low states based on the predefined condition, i.e., the threshold or the threshold range, that the target variable of interest may exhibit within the data model.

For example, the predefined condition for the target variable of interest may include high when the stock prices are greater than 800, medium when the stock prices are between 500-800, and low when the stock prices are below 500. This may be defined as per the nominal value of the stock price for a specific period of time.

Further, the input module 202 may be configured to receive an input corresponding to one or more user-defined trends of interest. The one or more user-defined trends of interest may refer to one or more patterns for analyzing the target variable of interest based on the one or more states. For example, the one or more user-defined trends of interest may include, but not limited to, recovery of the stock price from plummet and recovery from monotonic decrease in temperature.

Additionally, the input module 202 may be configured to receive one or more inputs associated with selection of one or more predetermined unsupervised learning based change point detection techniques. In an example, the one or more predetermined unsupervised learning based change point detection techniques may be developed for parametric and non-parametric settings. The one or more predetermined unsupervised learning based change point detection techniques may include, but are not limited to, bayesian online change point detection, cumulative sum control chart based change point detection, greedy gaussian segmentation of multivariate time series, and active multi-fidelity bayesian online changepoint detection. Further, the input module 202 may be configured to receive an input corresponding to a number of change points the selected one or more predetermined unsupervised learning based change point detection techniques should detect. In various embodiments of the present disclosure, the target variable of interest is segmented according to the number of the change points defined by the user in the input.

In an embodiment, the segmentation module 204 may be configured to segment the target variable of interest into two or more segments. According to various embodiments of the present disclosure, the segmentation module 204, for each data point of the plurality of sequential data points in the target variable of interest determines one or more probabilities of the data point being a change point and corresponding intensities of the one or more probabilities.

According to embodiments of the present disclosure, the one or more probabilities and the corresponding intensities are determined based on application of the user selected one or more predetermined unsupervised learning based change point detection techniques.

Further, the segmentation module 204 determines a change score based on the one or more probabilities of the data point. Furthermore, the segmentation module 204 may segment the target variable of interest into two or more segments based on the change score and the corresponding intensities of the one or more probabilities associated with each data point of the plurality of sequential data points in the target variable of interest.

In an example, when the target variable of interest is stock price, the segmentation module 202 may segment the plurality of data points associated with the stock prices into two or more segments based on one or more (in accordance with the user selected number of change points) unsupervised generic change points determined using the user selected one or more predetermined unsupervised learning based change point detection techniques.

In an embodiment, the trend determination module 206 may be configured to determine one or more trend scores based on corresponding intensities of the one or more user-defined trends of interest for each data point within the two or more segments.

According to various embodiments of the present disclosure, the trend determination module 206 classifies each data point within the two or more segments into one or more states with respect to the one or more user-defined trends of interest. In the aforementioned example, the trend determination module 206 may classify each data point within the two or more segments of the stock prices into one or more states of high, medium and low with respect to the one or more user-defined trends of interest, i.e., recovery from plummet. In an embodiment, the trend determination module 206 may perform the classification using a pre-defined Markov Chain Model (MCM).

Further, the trend determination module 206 determines one or more corresponding probability scores associated with the one or more states with respect to the one or more user-defined trends of interest. Furthermore, trend determination module 206 determines the one or more trend scores for each data point within the two or more segments based on the classification of each data point into one or more states and determination of the one or more corresponding probability scores associated with the one or more states.

In an embodiment, the output module 208 may be configured to determine distribution of the one or more trend scores across each of the two or more segments. In an example, the distribution of the one or more trend scores across each of the two or more segments of stock prices may correspond to statistical measures such as mean, variance, etc., which enable in characterization of the two or more segments of stock prices. Across different segments computed through the ensemble of generic change point methods, the present disclosure embodies a framework to model the specific change score obtained from the Markov chain-based module, enabling characterization of the dynamics of these changes during the identified periods. This characterization may leverage statistical methods such as hypothesis testing (e.g., Student's t-test, Kolmogorov-Smirnov test, Mann-Whitney U test, and Chi-square test), time-series decomposition techniques (e.g., wavelet transforms, empirical mode decomposition, seasonal-trend decomposition using locally weighted regression and scatterplot smoothing (LOESS) (STL)), and regression-based trend analysis (e.g., polynomial regression, autoregressive integrated moving average (ARIMA), and generalized additive models (GAM)).

Additionally, signal processing techniques such as Fourier transform, spectral analysis, short-time Fourier transform (STFT), Hilbert-Huang transform, and wavelet-based feature extraction may be employed to analyze both frequency-domain and temporal patterns of the detected changes. Further, machine learning-based approaches such as clustering (e.g., k-means, hierarchical clustering, Gaussian mixture models), anomaly detection (e.g., isolation forests, one-class support vector machine (SVM), dynamic time warping), and deep learning-based sequence models (e.g., long short-term memory (LSTM), transformers, and convolutional neural networks (CNN) for feature extraction) may also be utilized for advanced characterization and pattern discovery.

It should be noted that the present disclosure is not limited to the above-mentioned methods, and other statistical, signal processing, and machine learning techniques may be used based on the nature of the data and application requirements.

According to various embodiments of the present disclosure, the distribution of the one or more trend scores across each of the two or more segments indicates the analysis of the target variable of interest with respect to the one or more user-defined trends of interest.

According to various embodiments of the present disclosure, the output module 208 may predict one or more future segments based on the analysis of the target variable of interest with respect to the distribution of the one or more corresponding trend scores across each of the two or more segments.

In an embodiment, the output module 208 may be configured to generate an explanation of the prediction of one or more future segments. The explanation may be generated by applying an explainable AI (XAI) method to the predicted one or more future segments. Said explanation enhances the end user's understanding of the underlying processes that generate outputs based on user-defined patterns. Examples of XAI methods that may be used include, but are not limited to, feature attribution methods such as SHapley Additive exPlanations (SHAP), Local Interpretable Model-agnostic Explanations (LIME), Integrated Gradients, Layer-wise Relevance Propagation (LRP), and Grad-CAM for deep learning models; rule-based and surrogate models such as decision trees as surrogate models, Explainable Boosting Machines (EBM), and Bayesian Rule Lists; counterfactual and example-based explanations such as the Contrastive Explanations Method (CEM) and counterfactual explanations; and global and local explanation techniques such as Partial Dependence Plots (PDP), Accumulated Local Effects (ALE), and Individual Conditional Expectation (ICE). Furthermore, various frameworks and tools may be utilized for implementing explainability, including InterpretML, Captum, IBM's AI Explainability 360, and DeepLIFT. It should be noted that the present disclosure is not limited to the above-mentioned methods, and alternative XAI techniques may also be applied based on the nature of the predictive model, the underlying dataset, and specific user requirements.

According to various embodiments of the present disclosure, in response to analyzing the target variable of interest, information associated with business insights may be extracted based on the distribution of the one or more corresponding trend scores across each of the two or more segments. For example, in financial markets, trend score distributions may reveal market sentiment shifts, enabling the detection of early signals of volatility, bullish or bearish momentum, and sector-specific performance anomalies. In sales forecasting, the segmentation of trend scores may provide insights into seasonal demand patterns, promotional effectiveness, and shifts in consumer behavior across different regions or demographics. In risk management, analyzing the trend score distributions may help in identifying emerging operational risks, fraud patterns, or deviations from expected financial performance. In customer analytics, understanding trend score variations across different customer segments may improve churn prediction, enhance personalized recommendations, and optimize marketing campaigns. Additionally, in supply chain optimization, trend score analysis may be used to anticipate demand fluctuations, detect inefficiencies in logistics, and optimize inventory management. It should be noted that the present disclosure is not limited to the above-mentioned insights, and other business intelligence applications may also be derived depending on the specific industry and context of analysis.

Further, the output module 208 may be configured to output or generate a representation corresponding to the distribution of the one or more trend scores. According to various embodiments of the present disclosure, the representation is indicative of the analysis of the target variable of interest with respect to the one or more user-defined trends of interest. The representation may be output on a display associated with the system 100 via the user interface 104. In an example, the representation may be a graph generated based on the distribution of the one or more trend scores. In another example, the representation may be in the form of a tabular summary displaying statistical metrics such as mean, variance, skewness, and percentiles of the trend scores. Additionally, the representation may be in textual format, providing natural language-based insights or executive summaries describing key patterns, anomalies, and trend shifts. Furthermore, the representation may be structured as an interactive dashboard, allowing users to filter, drill down, or apply different analytical perspectives on the trend score data. The representation may also include an audio-based summary, or a report formatted for automated processing, such as JavaScript Object Notation (JSON), Extensible Markup Language (XML), or Comma Separated Value (CSV) files, facilitating integration with external systems. It should be noted that the present disclosure is not limited to the above-mentioned representations, and other suitable formats may also be used depending on user requirements and system configurations.

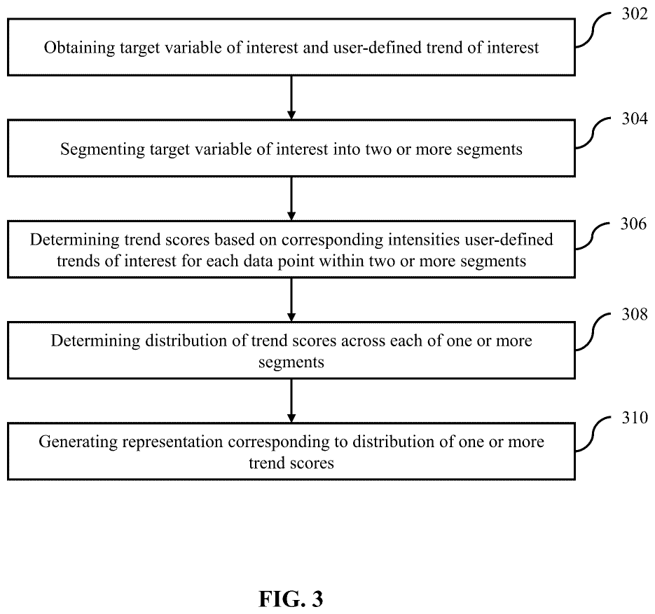

FIG. 3 illustrates an exemplary process flow comprising a method 300 for analyzing the target variable of interest with respect to the one or more user-defined trends of interest, according to an embodiment of the present disclosure. For the sake of brevity, details of the present disclosure that are explained in detail in the description of FIG. 1 and FIG. 2 are not explained in detail in the description of FIG. 3.

At step 302, the method 300 may include obtaining, by the input module 202, the target variable of interest and the one or more user-defined trends of interest. The target variable of interest corresponds to the plurality of sequential data points.

In some embodiments, the method 300 includes receiving, by the input module 202, the set of auxiliary features to the target variable of interest indicative of latent information of the target variable of interest. In some embodiments, the method 300 includes receiving, by the input module 202, the data model which is indicative of the transformation of time series.

The target variable of interest may be the attribute or element represented in the data model which is to be analysed with respect to one or more user-defined trends of interest. For example, the target variable of interest may be a plurality of sequential data points associated with stock prices, or a plurality of sequential data points associated with temperature values throughout the day. In the aforesaid example, the set of auxiliary variables may include stock price of relevant companies or temperature indices.

In some embodiments, the method 300 includes receiving, by the input module 202, the number of states the target variable of interest may be classified into. In some embodiments, the method 300 includes receiving, by the input module 202, the one or more user-defined trends of interest one or more user-defined trends of interest. In some embodiments, the method 300 includes receiving, by the input module 202, selection of one or more predetermined unsupervised learning based change point detection techniques. In some embodiments, the method 300 includes receiving, by the input module 202, the number of change points to be detected by the one or more predetermined unsupervised learning based change point detection techniques.

At step 304, the method 300 includes segmenting, by the segmentation module 204, the target variable of interest into two or more segments. In some embodiments, the method includes determining, by the segmentation module 204, for each data point of the plurality of sequential data points in the target variable of interest, the one or more probabilities of the data point being a change point and corresponding intensities of the one or more probabilities and the change score based on the one or more probabilities of the data point.

In some embodiments, the method 300 includes determining, by the segmentation module 204, the one or more probabilities and the corresponding intensities based on application of the one or more predetermined unsupervised learning based change point detection techniques.

Further, the method 300 includes segmenting, by the segmentation module 204, the target variable of interest into two or more segments based on the change score and the corresponding intensities of the one or more probabilities associated with each data point of the plurality of sequential data points in the target variable of interest.

At step 306, the method 300 includes determining, by the trend determination module 206, the one or more trend scores based on the corresponding intensities of the one or more user-defined trends of interest for each data point within the one or more segments.

In some embodiments, the method 300 includes classifying, by the trend determination module 206, each data point within the two or more segments into the one or more states with respect to the one or more user-defined trends of interest. In some embodiments, the method 300 includes performing the classification, by the trend determination module 206, using the pre-defined Markov Chain Model (MCM). The Markov Chain Model may include, but is not limited to, discrete-time Markov chains (DTMC), continuous-time Markov chains (CTMC), hidden Markov models (HMM), partially observable Markov decision processes (POMDP), absorbing Markov chains, ergodic Markov chains, and time-inhomogeneous Markov chains. These variants enable different modeling approaches based on the characteristics of the underlying trends, allowing the system to handle diverse temporal patterns, varying transition probabilities, and uncertainty in state observations. It should be noted that the present disclosure is not limited to the above-mentioned specific Markov Chain variants, and other probabilistic modeling techniques may also be employed depending on the use case.

Further, the method 300 includes determining, by the trend determination module 206, the one or more corresponding probability scores associated with the one or more states with respect to the one or more user-defined trends of interest. The probability scores may be determined using various probabilistic modeling techniques including, but not limited to, Bayesian inference, transition probability matrices in Markov Chain models, or likelihood estimation based on historical data patterns. The probability scores quantify the likelihood of a data point belonging to a particular state, allowing for robust state-based trend characterization.

Furthermore, the method 300 includes determining, by the trend determination module 206, the one or more trend scores for each data point within the one or more segments based on the classification of each data point into one or more states and the corresponding probability scores associated with these states. In some embodiments, the one or more trend scores may be determined using weighted state transition probabilities, entropy-based measures to quantify uncertainty in state classification, or time-series smoothing techniques such as moving averages, exponential smoothing, or Gaussian process regression. Additionally, the one or more trend scores may be further refined using ensemble learning techniques that aggregate multiple classification outputs to improve robustness and accuracy.

In another embodiment, the one or more trend scores may be normalized or standardized across different segments to ensure comparability and consistency in trend analysis. The normalization or standardization may be performed using methods such as, but not limited to, z-score normalization, min-max scaling, or quantile transformation to adjust for variations in data distribution.

Moreover, the probability scores and the one or more trend scores may be dynamically updated in real-time based on newly observed data, enabling adaptive trend detection. In one example, reinforcement learning-based approaches such as Q-learning or policy gradient methods may be employed to continuously optimize trend classification by learning from evolving data patterns.

It should be noted that the present disclosure is not limited to the aforementioned methods, and alternative statistical, probabilistic, or machine learning-based techniques may also be applied depending on the application requirements and data characteristics.

At step 308, the method 300 includes determining, by the output module 208, the distribution of the one or more trend scores across each of the one or more segments.

At step 310, the method 300 includes generating, by the output module 208, the representation corresponding to the distribution of the one or more trend scores. The representation may be indicative of the analysis of the target variable of interest with respect to the one or more user-defined trends of interest.

In some embodiments, the method 300 includes predicting, by the output module 208, one or more future segments based on the analysis of the target variable of interest with respect to the distribution of the one or more corresponding trend scores across each of the one or more segments.

In some embodiments, the method 300 includes extracting, by the output module 208, in response to analyzing the target variable of interest, information associated with business insights based on the distribution of the one or more corresponding trend scores across each of the one or more segments.

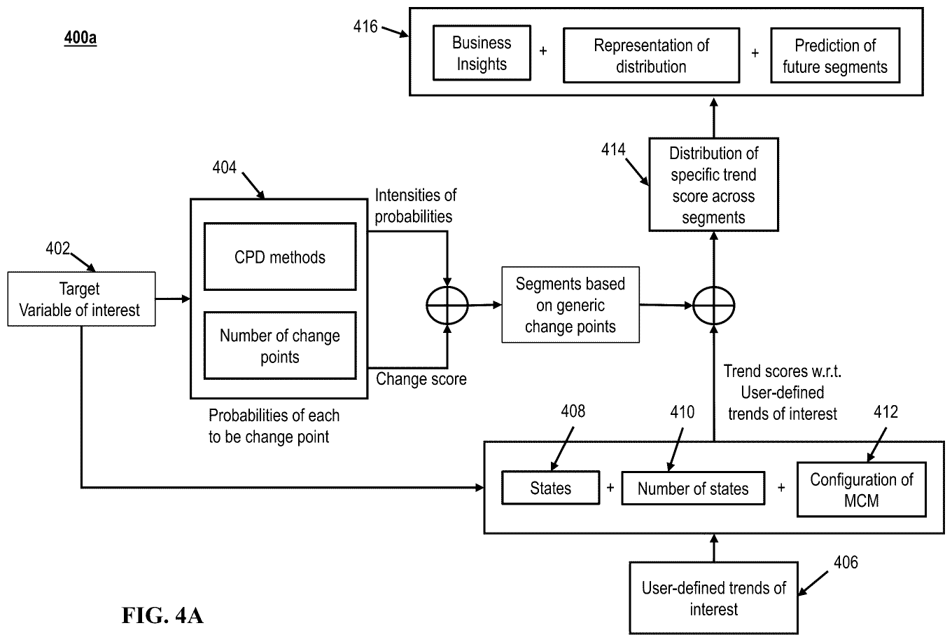

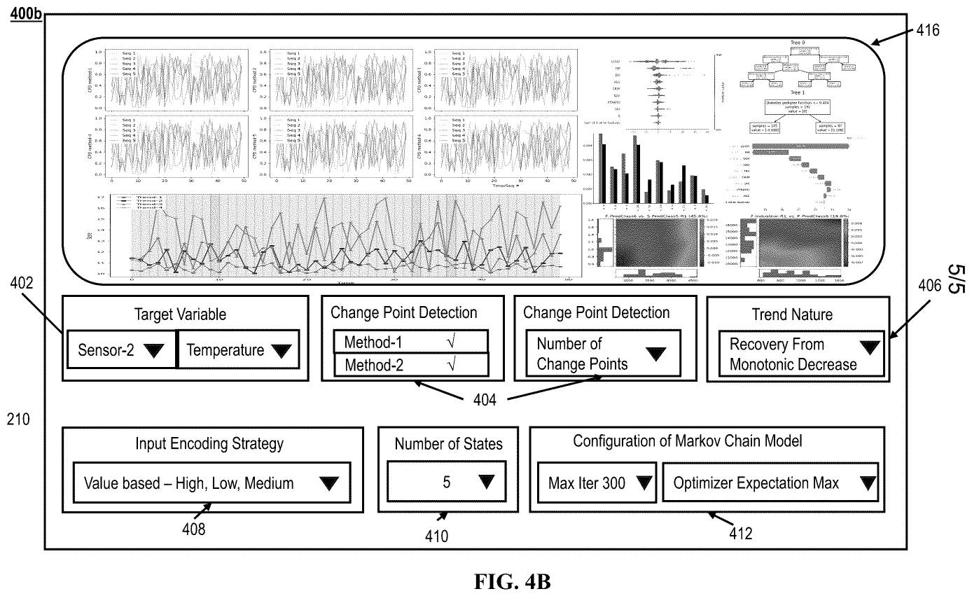

FIGS. 4A and 4B illustrate another exemplary workflow 400a for implementing the method 300 and a graphical user interface (GUI) 400b respectively for analyzing the target variable of interest with respect to the one or more user-defined trends of interest, according to an embodiment of the present disclosure.

At step 402 of the workflow 400a, the target variable is selected from the data model.

At step 404 of the workflow 400a, the one or more predetermined unsupervised learning based change point detection techniques are selected along with the number of change points to be detected. The user selected one or more predetermined unsupervised learning based change point detection techniques are implemented to segment the selected target variable into two or more segments.

At step 406 of the workflow 400a, the one or more trends of interest are selected by the user enabling classification of the target variable based on the user-defined trends of interest.

At step 408 of the workflow 400a, the one or more states are selected based on the user-defined trends of interest. The selection of one or more states is indicated as input encoding strategy in the GUI 400b. At step 410 of the workflow 400a, the number of states may be selected.

At step 412 of the workflow 400a, the configuration of the Markov Chain Model (MCM) is selected. The configuration parameters may be adapted based on the specific use case, data characteristics, and performance optimization objectives. In an example, the configuration may include parameters such as the number of states, transition probability initialization, convergence criteria, and computational constraints. The selection of these parameters influences the stability, accuracy, and interpretability of the model.

The configuration may also include hyperparameters such as maximum iterations, which define the upper bound for iterative optimization procedures, ensuring computational efficiency while balancing convergence speed. The error function may be used to evaluate the deviation between observed and predicted state transitions, with examples including mean squared error (MSE), Kullback-Leibler divergence, and log-likelihood maximization. Regularization functions may be applied to prevent overfitting and enhance generalization, such as L1 (Lasso) and L2 (Ridge) regularization for parameter sparsity and stability.

In some embodiments, the selection of the Markov Chain Model configuration may be dynamically optimized using adaptive techniques, including Bayesian optimization, grid search, or evolutionary algorithms such as genetic algorithms and particle swarm optimization. Additionally, reinforcement learning-based tuning mechanisms may be applied to iteratively adjust configuration parameters based on real-time performance feedback.

Furthermore, the configuration may incorporate extensions of Markov Chain models, such as hidden Markov models (HMM) for handling partially observable states, time-inhomogeneous Markov chains for dynamic transition probabilities, and higher-order Markov models for capturing complex sequential dependencies. Hybrid approaches integrating Markov models with deep learning architectures, such as recurrent neural networks (RNNs) or transformer-based sequence models, may also be used to enhance predictive capabilities. It should be noted that the present disclosure is not limited to the above-mentioned specific configurations, and alternative optimization, regularization, and hybrid modeling techniques may also be employed based on the requirements of the specific application domain, such as financial forecasting, anomaly detection, healthcare analytics, or industrial monitoring.

At step 414 of the workflow 400a, the Markov chain model is implemented based on the user selection to determine distribution of one or more trend scores across each of the two or more segments. The one or more trend scores are determined by the Markov chain model for each data point within the two or more segments.

At step 416 of the workflow 400a, the representation corresponding to the distribution of the one or more trend scores is generated. The generated representation may be displayed in the GUI 400b via the user interface 104 of the system 100.

While the above steps shown in FIGS. 3, 4A, and 4B are described in a particular sequence, the steps may occur in variations to the sequence in accordance with various embodiments of the present disclosure. Further, the details related to various steps of FIGS. 3, 4A, and 4B, which are already covered in the description related to FIGS. 1-2 are not discussed again in detail here for the sake of brevity.

In an exemplary use case scenario associated with manufacturing and process control, the systems and methods described herein enable detecting anomalies or changes in production processes that may indicate potential issues with quality control or machinery by segmenting operational data to monitor different stages of production and forecast future process changes, optimizing efficiency and reducing downtime.

In another exemplary use case scenario associated with demand forecasting, the systems and methods described herein enable identifying periods of high or low consumption and forecasting of future demand based on historical usage patterns.

In another exemplary use case scenario associated with anomaly detection in systems monitoring, the systems and methods described herein enable identifying irregular patterns in systems such as servers, IoT devices, or industrial machines, where detecting changes in behavior (e.g., a sudden spike in usage or a gradual degradation) helps in failure prevention. Said identification is made by segmenting data to track different operational states, such as normal, warning, and critical conditions.

In another exemplary use case scenario associated with retail and consumer behavior analysis, the systems and methods described herein enable segmenting consumer purchase patterns based on fluctuations in buying behavior to identify trends such as spikes in demand, seasonal changes, or an impact of promotional campaigns. Said segmentation further enables forecasting future shifts in consumer behavior to optimize inventory management and marketing strategies.

In this application, unless specifically stated otherwise, the use of the singular includes the plural, and the use of “or” means “and/or.” Furthermore, the use of the terms “including” or “having” is not limiting. Any range described herein will be understood to include the endpoints and all values between the endpoints. Features of the disclosed embodiments may be combined, rearranged, omitted, etc., within the scope of the invention to produce additional embodiments. Furthermore, certain features may sometimes be used to advantage without a corresponding use of other features.

While at least one exemplary embodiment has been presented in the foregoing detailed description, it should be appreciated that a vast number of variations exist.

We claim:

1. A method for analyzing a target variable of interest with respect to one or more user-defined trends of interest, the method comprising:
obtaining, by a processor, the target variable of interest and the one or more user-defined trends of interest, wherein the target variable of interest corresponds to a plurality of sequential data points;
segmenting the target variable of interest into two or more segments;
determining one or more trend scores based on corresponding intensities of the one or more user-defined trends of interest for each data point within the two or more segments;
determining distribution of the one or more trend scores across each of the two or more segments; and
generating a representation corresponding to the distribution of the one or more trend scores, wherein the representation is indicative of the analysis of the target variable of interest with respect to the one or more user-defined trends of interest.

2. The method as claimed in claim 1, wherein the segmenting comprises:
for each data point of the plurality of sequential data points in the target variable of interest:
determining one or more probabilities of the data point being a change point and corresponding intensities of the one or more probabilities; and
determining a change score based on the one or more probabilities of the data point; and
segmenting the target variable of interest into two or more segments based on the change score and the corresponding intensities of the one or more probabilities associated with each data point of the plurality of sequential data points in the target variable of interest.

3. The method as claimed in claim 2, wherein determining the one or more probabilities and the corresponding intensities comprises:
determining the one or more probabilities and the corresponding intensities based on application of one or more predetermined unsupervised learning based change point detection techniques.

4. The method as claimed in claim 1, wherein determining the one or more trend scores comprises:
classifying each data point within the two or more segments into one or more states with respect to the one or more user-defined trends of interest;
determining one or more corresponding probability scores associated with the one or more states with respect to the one or more user-defined trends of interest; and
determining the one or more trend scores for each data point within the two or more segments based on the classification of each data point into one or more states and determination of the one or more corresponding probability scores associated with the one or more states.

5. The method as claimed in claim 4, wherein the classification is performed using a pre-defined Markov Chain Model (MCM).

6. The method as claimed in claim 1, further comprising:
predicting one or more future segments based on the analysis of the target variable of interest with respect to the distribution of the one or more corresponding trend scores across each of the two or more segments.

7. The method as claimed in claim 1, further comprising:
in response to analyzing the target variable of interest, extracting information associated with business insights based on the distribution of the one or more corresponding trend scores across each of the two or more segments.

8. A system for analyzing a target variable of interest with respect to one or more user-defined trends of interest, the system comprising:
a memory; and
a processor coupled with the memory, the processor being configured to:
obtain the target variable of interest and the one or more user-defined trends of interest, wherein the target variable of interest corresponds to a plurality of sequential data points;
segment the target variable of interest into two or more segments;
determine one or more trend scores based on corresponding intensities of the one or more user-defined trends of interest for each data point within the two or more segments;
determine distribution of the one or more trend scores across each of the two or more segments; and
generating a representation corresponding to the distribution of the one or more trend scores, wherein the representation is indicative of the analysis of the target variable of interest with respect to the one or more user-defined trends of interest.

9. The system as claimed in claim 8, wherein for the segmenting, the processor is configured to:
for each data point of the plurality of sequential data points in the target variable of interest:
determine one or more probabilities of the data point being a change point and corresponding intensities of the one or more probabilities; and
determine a change score based on the one or more probabilities of the data point; and
segment the target variable of interest into two or more segments based on the change score and the corresponding intensities of the one or more probabilities associated with each data point of the plurality of sequential data points in the target variable of interest.

10. The system as claimed in claim 9, wherein for determining the one or more probabilities and the corresponding intensities, the processor is configured to:
determine the one or more probabilities and the corresponding intensities based on application of one or more predetermined unsupervised learning based change point detection techniques.

11. The system as claimed in claim 8, wherein for determining the one or more trend scores, the processor is configured to:
classify each data point within the two or more segments into one or more states with respect to the one or more user-defined trends of interest;
determine one or more corresponding probability scores associated with the one or more states with respect to the one or more user-defined trends of interest; and
determine the one or more trend scores for each data point within the two or more segments based on the classification of each data point into one or more states and determination of the one or more corresponding probability scores associated with the one or more states.

12. The system as claimed in claim 11, wherein the classification is performed using a pre-defined Markov Chain Model (MCM).

13. The system as claimed in claim 8, the processor is further configured to:
predict one or more future segments based on the analysis of the target variable of interest with respect to the distribution of the one or more corresponding trend scores across each of the two or more segments.

14. The system as claimed in claim 8, the processor is further configured to:
in response to analyzing the target variable of interest, extract information associated with business insights based on the distribution of the one or more corresponding trend scores across each of the two or more segments.
